(19) United States
(12) Patent Application Publication
(10) Pub. No.: US 2010/0025172 A1
(43) Pub. Date: Feb. 4, 2010

(54) SEGMENTED HEAT SHIELD ASSEMBLY

(75) Inventor: Steven C. Campbell, Troy, OH (US)

Correspondence Address: SNELL & WILMER L.L.P. (GOODRICH), ONE ARIZONA CENTER, 400 E. VAN BUREN STREET, PHOENIX, AZ, 85004-2202, US

(73) Assignee: GOODRICH CORPORATION, Charlotte, NC (US)

(21) Appl. No.: 12/443,788

(22) PCT Filed: Oct. 23, 2007
(86) PCT No.: PCT/US07/82200

§ 371 Date: Mar. 31, 2009

Related U.S. Application Data
(60) Provisional application No. 60/862,570, filed on Oct. 23, 2006.

(51) Int. Cl. F16D 65/847; F16D 65/78; F16D 65/84

(52) U.S. Cl. 188/264 AA; 188/264 G; 188/264 F

(57) ABSTRACT

A heat shield assembly for a wheel and brake assembly (10) wherein the heat shield (40) is securable to the wheel and brake assembly (10) by one or more slots formed in a torque bar (24). The slots (44) secure the heat shield (40) against radial and circumferential movement. The heat shield (40) can be axially inserted and removed from the wheel and brake assembly (10) without removal of the torque bars (24).

### RELATED APPLICATIONS

This application claims the benefit of U.S. Provisional Application No. 60/862,570 filed Oct. 23, 2006, which is hereby incorporated by reference.

### FIELD OF THE INVENTION

The invention herein described relates to aircraft wheel and brake assemblies and, more particularly, to improvements in heat shields and heat shield support structures.

### BACKGROUND OF THE INVENTION

An aircraft wheel and brake assembly typically includes a heat shield disposed between the wheel and brake disks to prevent conduction and radiation to the aircraft wheel of heat energy generated in the brake disks during braking. Excessive temperatures in the aircraft wheel can damage the wheel and the aircraft tire. The heat shield also prevents hot brake material ejected from the brake disks during braking from being slung against the inside of the wheel, which can also damage the wheel and further contribute to excessive temperatures.

An early example of a heat shield is described by U.S. Pat. No. 3,051,528 issued in 1962 to R. R. Rogers. The Rogers heat shield comprises a multitude of curved heat shield segments disposed between adjacent drive keys. More recent examples are described by U.S. Pat. No. 4,017,123 issued in 1977 to Horner et al. and U.S. Pat. No. 4,084,857 issued in 1978 to VanderVeen. These heat shields also comprise curved heat shield segments disposed between adjacent drive keys. The Horner et al. heat shield segments are captive between the drive key caps and ledges formed on the drive keys. The ledges and drive keys are integrally formed with the wheel, which is typical of wheel and brake assemblies having steel disks. Horner et al. states that the heat shield segments could be used with the removable keys presented in Rogers. However, exactly how this would be accomplished is not clear because the Rogers drive keys do not have ledges or drive key caps. The VanderVeen heat shield section is captive between the drive key cap and an additional cap having a pair of wings that extend from either side of the drive key. The drive keys are integrally formed with the wheel, and wings eliminate the need for the ledges of Horner et al. The heat shields described thus far are representative of the technology developed for wheel and brake assemblies having steel brake disks with metallic friction linings.

The advent of carbon/carbon brake disks instigated further development of heat shields. Carbon/carbon brakes generally operate at a much higher temperature than their steel counter-parts, which necessitated further steps to minimize conduction and radiation of heat energy into the aircraft wheel. Most wheel and brake assemblies having carbon/carbon brakes now have removable torque bars that are spaced from the inside of the aircraft wheel, with attachments at both ends. This arrangement minimizes the conductive path from the torque bars to the wheel. Heat shield contact with the torque bars is preferably minimized for the same reasons. In addition, radiation is a major source of heat transfer from carbon/carbon brakes, which necessitates that the heat shield fully encircle the brake disks with minimum holes or breaks that permit direct radiation of heat energy to the aircraft wheel. Conduction is another major source of heat transfer in carbon/carbon brakes, which is minimized by minimizing contact of the torque bars and heat shield with the aircraft wheel. These considerations caused a significant departure from the earlier heat shield technology developed for steel brakes.

According to one prior art approach, a single piece full circle heat shield is attached to the wheel and brake assembly between the wheel and the torque bars. The heat shield is spaced from both the torque bars and the aircraft wheel in order to minimize heat conduction to the heat shield from the torque bars. The heat shield comprises two cylindrical stainless steel sheets spaced from each other, with insulation in between. A heat shield constructed in such manner, though certainly safe and effective, embodies some undesirable characteristics. For example, the shield tends to warp and buckle during use due to thermal expansion and contraction induced by braking cycles. In addition, removing a damaged heat shield generally requires removing all the torque bars from the aircraft wheel assembly.

Further heat shield improvements are described in U.S. Pat. No. 5,851,056 issued in 1998 to Hyde. The Hyde heat shield comprises individual heat shield segments disposed between adjacent torque bars and elongate heat shield carriers superposing the torque bars and engaging the heat shield segments. With such an arrangement, the heat shield segments are removable without loosening or removing any torque bars.

Although the Hyde heat shield is an effective heat shield, it and similarly designed heat shields exhibit undesirable characteristics. Since the wheel acts as part of the pressure vessel to contain tire pressure, there is limited structure to which the heat shield segments and carriers can be mounted. For example, the heat shield sections and carriers of the Hyde heat shield are mounted at their axially inboard ends to the wheel flange and extend axially into the tube well. To provide support deep within the tube well, the heat shield carriers include resilient bumpers at their axially outboard ends. The resilient bumpers contact the tube well and restrain radial movement of the heat shield carriers and also the heat shield sections engaged by the carriers. During wheel spin up, the heat shield sections and carriers are forced radially outwardly and the resilient bumpers protect the tube well from being scored. However, over time the resilient bumpers have a tendency to degrade, which may cause the heat shield sections and/or carriers to contact and/or abrade the protective coatings of the tube well. Once the protective coating is removed, the wheel is susceptible to corrosion which can lead to the wheel being prematurely removed from service.

While the prior art heat shield designs are certainly effective, they typically require additional parts, are difficult to assemble, and/or are difficult to service without disassembly of at least a portion of the wheel.

### SUMMARY OF THE INVENTION

The present invention provides a heat shield assembly for a wheel and brake assembly wherein the heat shield is securable to the wheel and brake assembly via one or more slots formed in a torque bar. The slots secure the heat shield against radial and circumferential movement. The heat shield can be axially inserted and removed from the wheel and brake assembly without removal of the torque bars.

According to one aspect of the invention, a wheel and brake assembly comprises a wheel having an axis of rotation and including a tube well having an inboard end and outboard end, and at least one torque bar attached to the tube well for transferring torque from the wheel to brake components located radially inwardly of the tube well. The torque bar includes a slot on a circumferential side thereof. A heat shield is disposed radially inwardly of the tube well and includes edge portions received within the slot in the torque bar. The slot restrains radial and circumferential movement of the heat shield while permitting axial movement of the heat shield.

More particularly, the torque bar has an inboard slot and an outboard slot for receiving the edge portion of the heat shield. Each torque bar can further include a slot intermediate the inboard slot and the outboard slot. The heat shield can include a plurality of circumferentially arranged heat shield sections, each heat shield section having edge portions received within the at least one slot of a respective circumferentially adjacent torque bar. The edge portion of the heat shield can include a radially inwardly turned edge portion that can be L-shape, with a distal leg of the L-shape portion corresponding in width to a radial width of the slot.

According to another aspect of the invention, a heat shield and torque bar assembly for a wheel and brake assembly comprises a plurality of heat shield sections, each section having edge portions on respective opposite circumferential sides thereof, and a plurality of torque bars attachable to a tube well for transferring torque from the wheel to brake components located radially inwardly of the tube well. Each torque bar includes a slot on a circumferential side thereof for retaining an edge portion of a respective heat shield so as to restrain radial and circumferential movement of the heat shield while permitting axial movement of the heat shield.

According to a further aspect of the invention, a torque bar for a wheel and brake assembly comprises an elongated bar and at least one slot for retaining an edge portion of a heat shield section when the torque bar is installed in a wheel and brake assembly.

According to still another aspect of the invention, a heat shield for a wheel and brake assembly comprises a central portion and radially inwardly turned edge portions circumferentially adjacent the central portion configured to be inserted into slots in a torque bar. The edge portions can be L-shape.

Further features of the invention will become apparent from the following detailed description when considered in conjunction with the drawings.

### BRIEF DESCRIPTION OF THE DRAWINGS

FIG. 1 is a cross-sectional view of a wheel and brake assembly employing a heat shield assembly in accordance with the invention.

FIG. 2 is an arcuate portion of a front/inboard end view of the wheel and brake assembly of FIG. 1, looking into the wheel from the left side of FIG. 1.

FIG. 3A is a perspective view of a torque bar used in the wheel and brake assembly of FIG. 1.

FIG. 3B is a top view of the torque bar.

FIG. 3C is a longitudinal cross-sectional view of the torque bar taken along the line 3C-3C of FIG. 3B.

FIG. 3D is an end view of the torque bar as viewed from the line 3D-3D of FIG. 3B.

FIG. 4 is a perspective view of a heat shield section of the heat shield.

FIG. 5 is a perspective view of the torque bar of FIGS. 3A-3D and an adjacent heat shield section, as viewed from the axially outboard side.

FIG. 6 is a perspective view of the torque bar and heat shield section of FIG. 5, as viewed from the axially inbound side.

### DETAILED DESCRIPTION

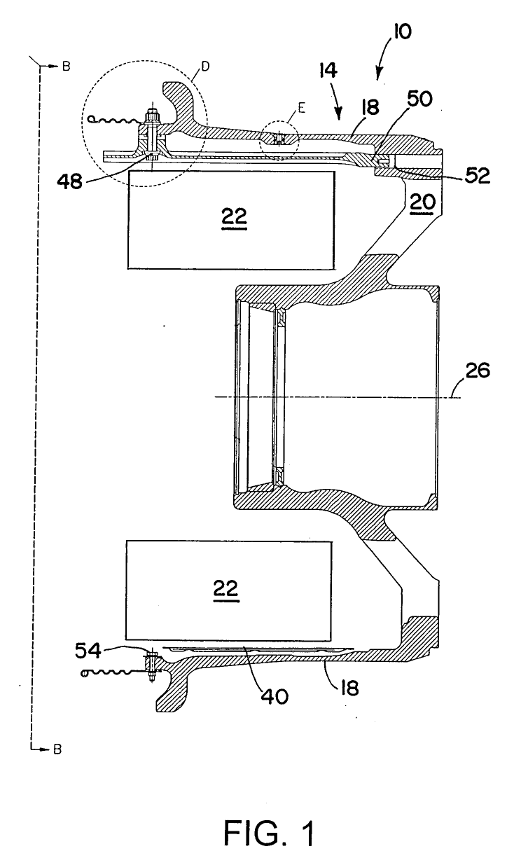

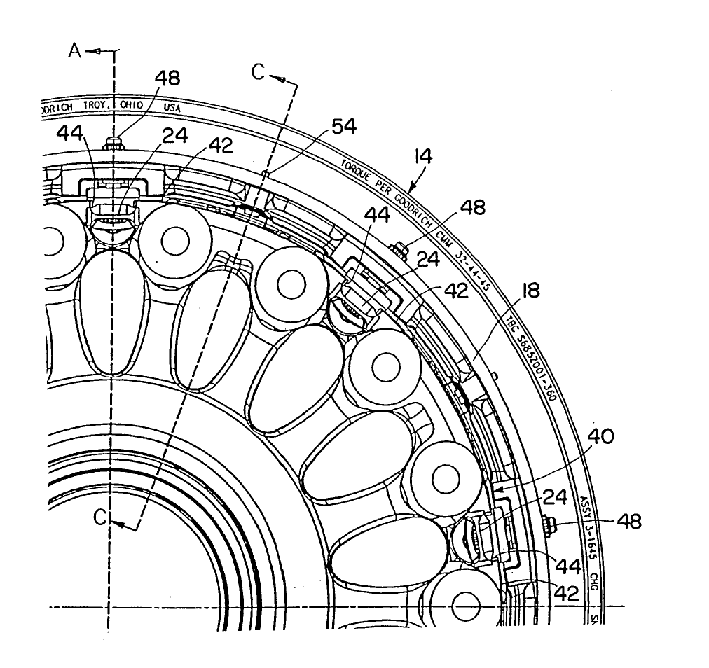

Referring now to the drawings in detail and initially to FIGS. 1-2, an exemplary wheel and brake assembly in accordance with the invention is indicated generally by reference numeral 10. The aircraft wheel and brake assembly 10 is mountable on an aircraft bogie axle (not shown).

The wheel and brake assembly 10 comprises a wheel 14 (only one wheel-half shown for clarity) having a hub 16 and a tube well 18 concentric with the hub 16, and a web 20 interconnecting the hub 16 and the tube well 18. A torque take-out assembly (e.g., brake components) shown schematically at reference numeral 22 is aligned with the hub 16, and the wheel 14 is rotatable relative to the torque take-out assembly 22.

As shown in FIG. 2, a plurality of torque bars 24 are fixed to the wheel 14 generally parallel to the axis of rotation 26 of the wheel and spaced from the tube well 18. As will be appreciated, the torque take-out assembly 22 may include a heat sink which may comprise brake or friction disks in the form of rotors and stators. The rotors typically would be engaged with the torque bars 24 for rotation with the wheel, and the stators would be engaged with the torque take-out assembly 22 which is fixed against rotation relative to a landing gear strut (not shown). An actuator can be provided to compress the heat sink in a conventional manner.

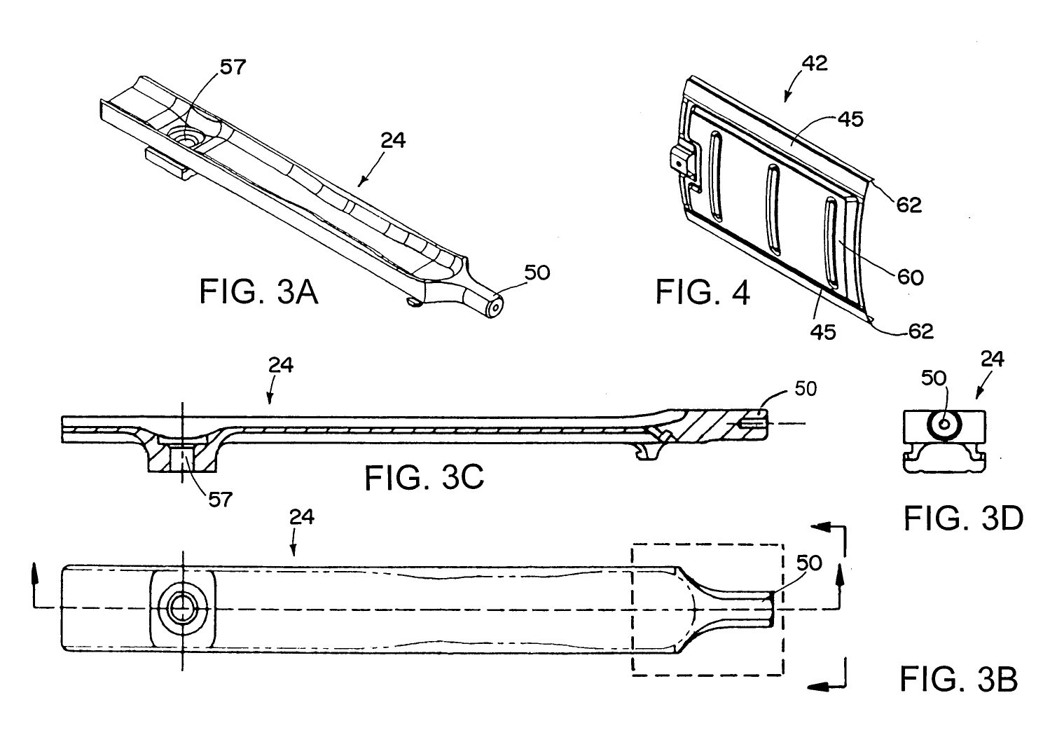

A heat shield 40, according to one aspect of the invention, is attached to the wheel 14 between the tube well 18 and the torque take-out assembly 22. As illustrated in FIGS. 1 and 2, the heat shield 40 is concentric with the tube well 18 and has a plurality of heat shield sections (also called segments) 42 disposed between respective, relatively adjacent pairs of torque bars 24. The heat shield sections 42 are spaced from the tube well 18 and secured in place by one or more slots 44 in the torque bars 24. The one or more slots 44, as will be described in more detail below, are disposed along a circumferential edge of the torque bar 24 and configured to receive an edge portion 45 of a heat shield section 42. Two or more slots 44, such as outboard slots 44a and inboard slots 44b (see FIGS. 3A-3D), can be spaced apart axially along the length of the torque bar 24 for receiving the edge portion of the heat shield section in more than one location. The slots 44 are shaped and/or sized for axially receiving and radially and circumferentially constraining the edge portions 45 of the heat shield segments 42, as described below with greater particularity.

The torque bars 24 are attached at their axially inboard end to the wheel 14 by torque bar bolts 48. The torque bar bolts 48 extend through respective holes in a flange provided on the wheel as shown, which flange for purposes of the present description is intended to be considered as part of the tube well. Each torque bar 24 preferably has a pin 50 at its axially outboard end (i.e., the end opposite the torque bar bolts 48) that is received within a hole 52 in the web 20 of the wheel.

After axial insertion between respective pairs of torque bars 24, the heat shield sections 42 may be secured in place to the tube well 18 by suitable means, such as fasteners, and more particularly heat shield bolts 54 (FIGS. 1 and 2). Other securement devices may also be employed.

Turning to FIGS. 3A-3D, details of an exemplary torque bar 24 are shown. Each torque bar 24 is substantially rectangular-shaped in cross-section (FIG. 3D) and has a mounting hole 57 at its axially inboard end that receives the torque bar bolt 48. Each torque bar 24 also includes, on opposite circumferential edges, a pair of slots 44a and 44b, with slots 44a being outboard slots and slots 44b being inboard slots. As mentioned, the slots 44a and 44b are adapted to axially receive an edge portion of a heat shield segment 42. The outboard slots 44a and inboard slots 44b are spaced apart axially along the length of the torque bar 24, with the outboard slots 44a having a shorter axial length than the inboard slots 44b. As best shown in FIGS. 3A and 3D, the illustrated slots 44a and 44b extend radially outwardly from the body of the torque bar 24 and are generally u-shape in cross section for receiving the edge of a heat shield segment 42. It will be appreciated that any suitable number of slots can be provided on a given circumferential edge, and the axial length of the slots can vary. For example, a single slot could be provided that extends substantially the entire length of the torque bar 24. Further, an intermediate slot could be provided between outboard slot 44a and inboard slot 44b. The structure forming the slots 44a and 44b and the torque bar 24 can be a unitary member (e.g., the slots 44a and 44b are formed in the torque bar 24) or the slots 44a and 44b can be formed by separate members secured to the torque bar 24.

Turning to FIG. 4, an exemplary heat shield segment 42 is illustrated. The heat shield segment 42 includes a relatively thick central portion and edge portions 45 circumferentially adjacent the central portion 60 configured to be inserted into slots 44 in the torque bar 24. The edge portions 45 include an L-shape portion 62 wherein a distal leg of the L-shape portion is turned radially inwardly. The distal leg of the L-shape portion 62 corresponds in width to a radial width of the slots 44a and 44b.

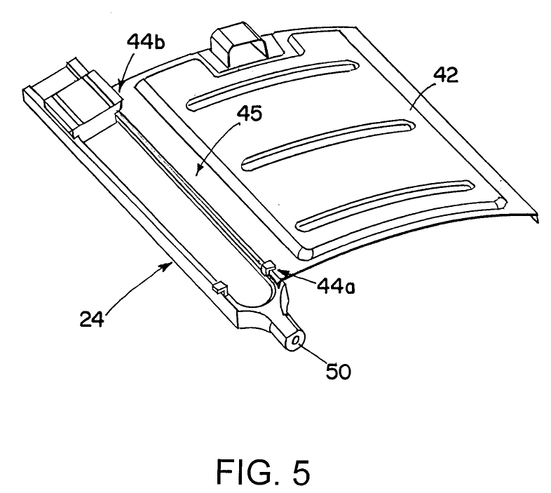

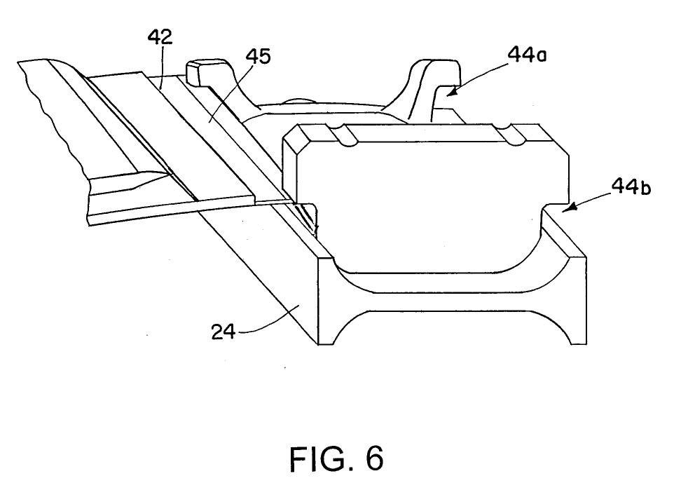

Turning to FIGS. 5 and 6, the torque bar 24 is illustrated with an edge portion 45 of a heat shield segment 42 received within slots 44a and 44b. As best seen in FIG. 6, the heat shield segment 42 is restrained radially and circumferentially by slots 44a and 44b of torque bar 24. As mentioned, heat shield bolt 54 secures the heat shield segment 42 in place and prevents axial movement thereof.

It will be appreciated that the heat shield sections 42 may be damaged such that replacement is needed before scheduled maintenance of the wheel and brake assembly. If this occurs, one or more damaged heat shield sections 42 may be replaced by removing the heat shield bolts 54 for those sections, axially withdrawing the damaged sections from the wheel and heat assembly, inserting new heat shield sections 42, and replacing the heat shield bolts 54. This may be accomplished without removing the torque bars 24, thus greatly facilitating field repair of the heat shield 40.

It will be appreciated that the heat shield and torque bar assembly set forth above not only can be serviced without removing the torque bars 24, but also has relatively few parts compared to other prior art designs while providing comparable functionality and/or performance.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A wheel and brake assembly comprising:
a wheel having an axis of rotation and including a tube well having an inboard end and outboard end;
at least one torque bar attached to the tube well for transferring torque from the wheel to brake components located radially inwardly of the tube well, the torque bar including a slot on a circumferential side thereof; and
a heat shield disposed radially inwardly of the tube well, the heat shield including an edge portion received within the slot;
whereby the slot restrains radial and circumferential movement of the heat shield while permitting axial movement of the heat shield.

2. A wheel and brake assembly as set forth in claim 1, wherein the at least one torque bar has an inboard slot and an outboard slot for receiving the edge portion of the heat shield.

3. A wheel and brake assembly as set forth in claim 1, wherein the heat shield includes a plurality of circumferentially arranged heat shield sections, each heat shield section having edge portions received within the slots of respective circumferentially adjacent torque bars (24), wherein the slots of respective torque bars retain respective edge portions of each heat shield section so as to restrain radial and circumferential movement while permitting axial movement of the heat shield section.

4. A wheel and brake assembly as set forth in claim 1, wherein the edge portion of the heat shield section includes a radially inwardly turned edge portion.

5. A wheel and brake assembly as set forth in claim 4, wherein the radially inwardly turned edge portion is L-shape, and wherein a distal leg of the radially inwardly turned edge portion corresponds in width to a radial width of the slot.

6. A wheel and brake assembly as set forth in claim 1, wherein the at least one torque bar has at least one slot on each circumferential side thereof.

7. A wheel and brake assembly as set forth in claim 1, wherein the structure of the torque bar and slot is unitary.

8. A heat shield and torque bar assembly for a wheel and brake assembly, comprising:
a plurality of heat shield sections, each section having edge portions on respective opposite circumferential sides thereof; and
a plurality of torque bars attachable to a tube well for transferring torque from the wheel to brake components located radially inwardly of the tube well, each torque bar including a slot on a circumferential side thereof for retaining an edge portion of a respective heat shield section so as to restrain radial and circumferential movement of the heat shield section while permitting axial movement of the heat shield section.

9. A heat shield and torque bar assembly as set forth in claim 8, wherein the torque bars have an inboard slot and an outboard slot for receiving an edge portion of a heat shield section.

10. A heat shield and torque bar assembly as set forth in claim 8, wherein the edge portions of the heat shield sections include a radially inwardly turned edge portion.

11. A wheel and brake assembly as set forth in claim 10, wherein the radially inwardly turned edge portion is L-shape, and wherein a distal leg of the radially inwardly turned edge portion corresponds in width to a radial width of the slot.

12. A wheel and brake assembly comprising a wheel having an axis of rotation and including a tube well having inboard and outboard ends; and the heat shield and torque bar assembly of claim 8 disposed radially inwardly of the tube well, wherein the torque bars extend generally parallel to the axis of rotation of the wheel.

13. A wheel and brake assembly as set forth in claim 8, wherein the structure of the torque bar and slot is unitary.

14. A wheel and brake assembly as set forth in claim 8, wherein each torque bar includes a slot on each circumferential side thereof.

15. A torque bar for a wheel and brake assembly, comprising an elongated bar and at least one slot for retaining an edge portion of a heat shield section when the torque bar is installed in a wheel and brake assembly.

16. A torque bar as set forth in claim 15, further comprising a second slot spaced apart along the length of the torque bar for retaining an edge portion of a heat shield section when the torque bar is installed in a wheel and brake assembly.

17. A torque bar as set forth in claim 15, wherein the structure of the torque bar and slot is unitary.

18. A heat shield for a wheel and brake assembly, comprising a central portion and radially inwardly turned edge portions circumferentially adjacent the central portion.

19. A heat shield as set forth in claim 18, wherein the edge portions are L-shape edge portions.
